(19) United States
(12) Patent Application Publication
(10) Pub. No.: US 2025/0267495 A1
(43) Pub. Date: Aug. 21, 2025

(54) CROSS-LINK INTERFERENCE REPORTING

(71) Applicant: Nokia Technologies Oy, Espoo (FI)

(72) Inventors: Roberto MALDONADO, Aalborg (DK); Jie GAO, Hangzhou (CN); Youngsoo YUK, Seoul (KR); Nhat-Quang NHAN, Reims (FR); Jing Yuan SUN, Beijing (CN)

(73) Assignee: Nokia Technologies Oy, Espoo (FI)

(21) Appl. No.: 19/051,554

(22) Filed: Feb. 12, 2025

(30) Foreign Application Priority Data
Feb. 15, 2024 (WO) PCT/CN2024/077251

(51) Int. Cl. H04W 24/10; H04B 17/309

(52) U.S. Cl. CPC H04W 24/10; H04B 17/346

(57) ABSTRACT

Embodiments of the present disclosure relate to cross-link interference (CLI) reporting. In an aspect, a terminal device receives, from a network device, a CLI measurement configuration indicating that a threshold for CLI reporting is adjustable. The terminal device further adjusts the threshold based on downlink (DL) channel quality, and transmits, to the network device, a CLI report based on a CLI measurement and the adjusted threshold. In this way, the CLI reporting can be triggered based on the adaptive threshold efficiently, thus transmissions of the unnecessary CLI reporting can be reduced.

### FIELD

Various example embodiments relate to the field of communication and in particular, to devices, methods, apparatuses and a computer readable storage medium for cross-link interference reporting.

### BACKGROUND

A communication network can be seen as a facility that enables communications between two or more communication devices, or provides communication devices access to a data network. A mobile or wireless communication network is one example of a communication network. Such communication networks operate in according with standards such as those provided by 3GPP (Third Generation Partnership Project) or ETSI (European Telecommunications Standards Institute). Examples of standards are the so-called 5G (5th Generation) standards provided by 3GPP.

With the development of communication technology, duplexing schemes such as time division duplex (TDD) for unpaired bands and sub-band non-overlapping full duplex (SBFD) have been studied. These duplexing schemes provide flexibility for uplink (UL) and downlink (DL) traffic switching, but also bring the potential cost of undesirable cross-link interference (CLI).

### SUMMARY

In general, example embodiments of the present disclosure provide a solution for the CLI reporting, especially for an adaptive threshold for an event-triggered UE-to-UE CLI measurements.

In a first aspect, there is provided a terminal device. The terminal device comprises at least one processor and at least one memory storing instructions that, when executed by the at least one processor, cause the terminal device at least to: receive, from a network device, a cross-link interference, CLI, measurement configuration, wherein the CLI measurement configuration indicates that a threshold for CLI reporting is adjustable; adjust, at the terminal device, the threshold based on downlink, DL, channel quality; and transmit, at the terminal device and to the network device, a CLI report based on a CLI measurement and the adjusted threshold.

In a second aspect, there is provided a network device. The network device comprises at least one processor; and at least one memory storing instructions that, when executed by the at least one processor, cause the network device at least to: transmit, to a terminal device, a cross-link interference, CLI, measurement configuration, wherein the CLI measurement configuration indicates that a threshold for CLI reporting is adjustable; and receive, at the network device, a CLI report from the terminal device.

In a third aspect, there is provided a method. The method comprises receiving, at a terminal device and from a network device, a cross-link interference, CLI, measurement configuration, wherein the CLI measurement configuration indicates that a threshold for CLI reporting is adjustable; adjusting, at the terminal device, the threshold based on downlink, DL, channel quality; and transmitting, at the terminal device and to the network device, a CLI report based on a CLI measurement and the adjusted threshold.

In a fourth aspect, there is provided a method. The method comprises transmitting, at a network device and to a terminal device, a cross-link interference, CLI, measurement configuration, wherein the CLI measurement configuration indicates that a threshold for CLI reporting is adjustable; and receiving, at the network device, a CLI report from the terminal device.

In a fifth aspect, there is provided an apparatus comprising: means for receiving, at a terminal device and from a network device, a cross-link interference, CLI, measurement configuration, wherein the CLI measurement configuration indicates that a threshold for CLI reporting is adjustable; means for adjusting, at the terminal device, the threshold based on downlink, DL, channel quality; and means for transmitting, at the terminal device and to the network device, a CLI report based on a CLI measurement and the adjusted threshold.

In a sixth aspect, there is provided an apparatus comprising: means for transmitting, at a network device and to a terminal device, a cross-link interference, CLI, measurement configuration, wherein the CLI measurement configuration indicates that a threshold for CLI reporting is adjustable; and means for receiving, at the network device, a CLI report from the terminal device.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to: receive, at a terminal device and from a network device, a cross-link interference, CLI, measurement configuration, wherein the CLI measurement configuration indicates that a threshold for CLI reporting is adjustable; adjust, at the terminal device, the threshold based on downlink, DL, channel quality; and transmit, at the terminal device and to the network device, a CLI report based on a CLI measurement and the adjusted threshold.

In a ninth aspect, there is provided a computer program comprising instructions, which, when executed by an apparatus, cause the apparatus at least to: transmit, at a network device and to a terminal device, a cross-link interference, CLI, measurement configuration, wherein the CLI measurement configuration indicates that a threshold for CLI reporting is adjustable; and receive, at the network device, a CLI report from the terminal device.

In a tenth aspect, there is provided a terminal device comprising: receiving circuitry configured to receive, at the terminal device and from a network device, a cross-link interference, CLI, measurement configuration, wherein the CLI measurement configuration indicates that a threshold for CLI reporting is adjustable; adjusting circuitry configured to adjust, at the terminal device, the threshold based on downlink, DL, channel quality; and transmitting circuitry configured to transmit, at the terminal device and to the network device, a CLI report based on a CLI measurement and the adjusted threshold.

In an eleventh aspect, there is provided a network device comprising: transmitting circuitry configured to transmit, at the network device and to a terminal device, a cross-link interference, CLI, measurement configuration, wherein the CLI measurement configuration indicates that a threshold for CLI reporting is adjustable; and receiving circuitry configured to receive, at the network device, a CLI report from the terminal device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example communication system in which embodiments of the present disclosure may be implemented;

FIG. 2 illustrates an example of a process for the CLI reporting according to some embodiments of the present disclosure;

FIG. 3 illustrates an example of the adaptive threshold according to some embodiments of the present disclosure;

FIG. 4 illustrates an example of a start and an end of the CLI reporting according to some embodiments of the present disclosure;

FIG. 5 illustrates an example of a process of the CLI reporting based on decoding of DL signals according to some embodiments of the present disclosure;

FIG. 6 illustrates a flowchart of a method implemented at a terminal device according to some embodiments of the present disclosure;

FIG. 7 illustrates a flowchart of a method implemented at a network device according to some embodiments of the present disclosure;

FIG. 8 illustrates a simplified block diagram of an apparatus that is suitable for implementing embodiments of the present disclosure; and

FIG. 9 illustrates a block diagram of an example computer readable medium in accordance with some embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, a mechanism of CLI reporting needs to be investigated for CLI management or mitigation. In the dynamic TDD scheme, the UE may be configured to send a CLI report given certain condition is met (also referred to as event-triggered reporting). Specifically, as defined by an i1-event, the UE may be configured to start CLI reporting when a measured CLI strength is above a sum of a certain i1-threshold and a hysteresis value, and stop the CLI reporting when a sum of a measured CLI strength and the hysteresis value is below the certain i1-threshold.

However, the above event-triggered reporting is based on absolute power, i.e., a constant threshold value and this may cause a few problems. For example, it is difficult for the gNB to predict a correct value for the threshold. A misconfiguration of the threshold might lead to excess of CLI reports or lack of reports. The UE configured with a too-low threshold will “over-report” and will consume physical uplink shared channel (PUSCH) or physical uplink control channel (PUCCH) resources that could be used for other purposes. In contrast, the UE configured with a too-high threshold wont report CLI even though the UE might be affected by UE-to-UE CLI.

Moreover, the above event-triggered reporting based on the constant threshold value would not reflect the “tolerance” of the UE to the CLI. For example, the UE could experience a relative high UE-to-UE CLI (potentially triggering an event i1), however, the UE could also receive an intended DL signal with enough power such that a signal to interference plus noise ratio (SINR) of the UE is not highly affected by the CLI. In this case, the UE may have a high tolerance to the CLI and thus the CLI reporting under such good SINR conditions may be unnecessary, thereby increasing resource consumption for the CLI reporting.

Particularly, as compared to the dynamic TDD, the SBFD introduces intra-cell UE-to-UE CLI which can increase the variability of the CLI conditions. Ideally, the network should dynamically re-configure via radio resource control (RRC) signaling the i1-threshold, but RRC signaling implies high latency. Moreover, the fundamental CLI measured in the UL sub-band is not the CLI that actually leaks to the DL sub-band, but the DL sub-band is ultimately the band of interest from CLI point of view. Thus the CLI reporting may be triggered inappropriately based on the CLI measured in the UL sub-band, and unnecessary CLI reports may be transmitted to the network.

According to some embodiments of the present disclosure, there is provided a solution for the CLI reporting. In this solution, a terminal device receives, from a network device, a CLI measurement configuration which indicates that a threshold for CLI reporting is adjustable. The terminal device further adjusts the threshold based on DL channel quality, and transmits, to the network device, a CLI report based on a CLI measurement and the adjusted threshold. As such, with the threshold being adjusted based on the DL channel quality, the CLI reporting can be triggered based on the adaptive threshold efficiently, thus transmissions of the unnecessary CLI reporting can be reduced.

Principles and embodiments of the present disclosure will be described in detail below with reference to the accompanying drawings. However, it is to be noted that these embodiments are illustrated as examples and not intended to limit scope of the present application in any way.

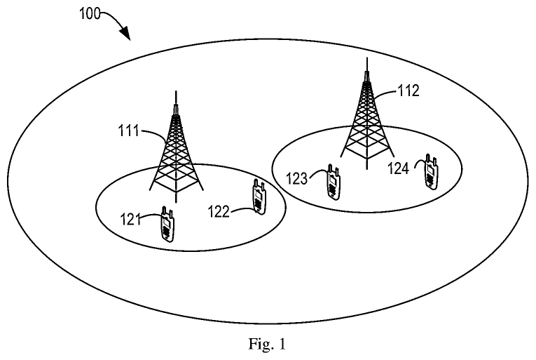

Reference is first made to FIG. 1, which illustrates an example communication system 100 in which embodiments of the present disclosure may be implemented. As illustrated in FIG. 1, the system 100 includes network device 111 and network device 112. The network devices 111 and 112 may each serve one or more cells in both DL and UL. In communication systems, “UL” refers to a communication link in a direction from a terminal device to a network device, and “DL” refers to a communication link in a direction from the network device to the terminal device.

The system 100 also includes one or more terminal devices, such as terminal devices 121, 122, 123 and 124. The terminal devices 121, 122, 123 and 124 are capable of connecting and communicating in an UL or DL with either or both of the network devices 111 and 112 depending on location of the terminal devices in the cells of the network devices 111 and 112. As shown in FIG. 1, the network device 111 may serve the terminal devices 121, 122 and the network device 112 may serve the terminal devices 123, 124.

In some embodiments, the dynamic TDD scheme may be applied and the terminal device 122 and the terminal device 123 may suffer inter cell UE-to-UE CLI. For example, the terminal device 122 may transmit UL signals to the network device 111 and the terminal device 123 may receive DL signals from the network device 112 at the same time. In this case, the device 123 might be interfered with inter cell UE-to-UE CLI.

In some embodiments, the SBFD scheme may be applied and the terminal devices 123 and 124 may suffer intra cell UE-to-UE CLI. For example, the terminal device 123 may transmit UL signals in an UL sub-band to the network device 112 and the terminal device 124 may receive DL signals in a DL sub-band from the network device 112 at the same time. In this case, the device 124 might be interfered with intra cell UE-to-UE CLI. The non-overlapping UL sub-band and the DL sub-band may be separated by a guard-band.

Moreover, the terminal device 123 and the terminal device 122 may also suffer inter cell UE-to-UE CLI. For example, the terminal device 123 may transmit UL signals in the UL sub-band to the network device 112 while the terminal device 122 receives DL signals in a DL sub-band from the network device 111.

It is to be understood that FIG. 1 is illustrated only for the purpose of illustration without suggesting any limitations. For example, the system 100 may include any suitable number of network devices and terminal devices adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

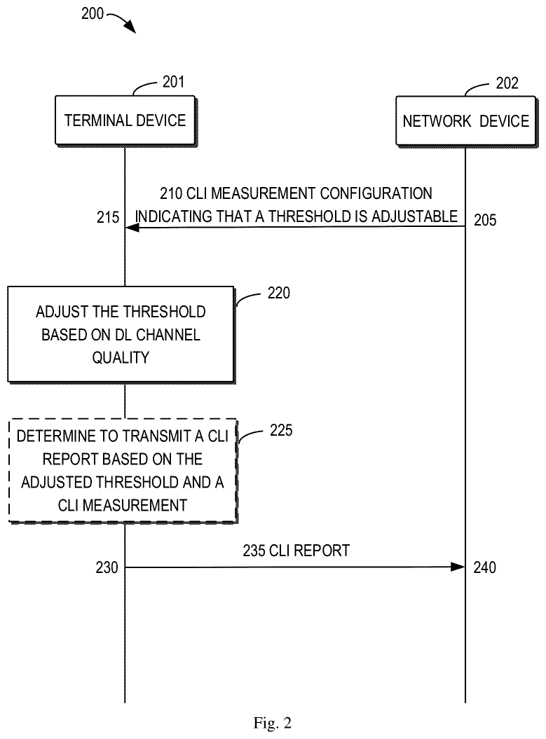

Reference is now made to FIG. 2, which shows an example of a process 200 for the CLI reporting according to an embodiment of the present disclosure. For the purpose of discussion, the process 200 will be described with reference to FIG. 1.

As shown in FIG. 2, the terminal device 201 and the network device 202 may be involved in the process 200. The terminal device 201 may be an example of the terminal devices 121, 122, 123 and 124, and the network device 202 may be an example of the network device 111 or 112 for the purpose of illustration.

In the process 200, the network device 202 transmits 205, to the terminal device 201, a CLI measurement configuration 210 indicating that a threshold for the CLI reporting is adjustable. In some embodiments, the CLI measurement may be a CLI-RSSI measurement or a sounding reference signal (SRS) reference signal received power (RSRP) measurement. In some embodiments, the network device 202 may transmit 205 the CLI measurement configuration 210 via the RRC signaling.

In some embodiments, the CLI measurement configuration 210 may comprise a field (such as an existing field) indicating an original value of the threshold, and comprise an additional field indicating that the threshold is adjustable.

For example, the network device 202 may reuse a CLI-EventTriggerConfig-r16 information element defined in the 3GPP specification and add an additional adaptive threshold field to indicate that the threshold is adjustable. An example of the modified CLI-EventTriggerConfig-r16 information element is shown below.

| | |
|---|---|
| CLI-EventTriggerConfig-r16 ::= | SEQUENCE { |
| eventId-r16 | CHOICE { |
| eventI1-r16 | SEQUENCE { |
| i1-Threshold-r16 | MeasTriggerQuantityCLI-r16, |
| i1-AdaptiveThreshold | BOOLEAN, |
| reportOnLeave-r16 | BOOLEAN, |
| hysteresis-r16 | Hysteresis, |
| timeToTrigger-r16 | TimeToTrigger |

},

Alternatively, the CLI measurement configuration 210 may use a new adaptive threshold field to indicate an original value of the threshold and indicate that the threshold is adjustable. Another example of the modified CLI-EventTriggerConfig-r16 information element is shown below.

| | |
|---|---|
| CLI-EventTriggerConfig-r16 ::= | SEQUENCE { |
| eventId-r16 | CHOICE { |
| eventI1-r16 | SEQUENCE { |
| i1-AdaptiveThreshold | MeasTriggerQuantityCLI-r16, |
| reportOnLeave-r16 | BOOLEAN, |
| hysteresis-r16 | Hysteresis, |
| timeToTrigger-r16 | TimeToTrigger |

},

In some embodiments, the CLI measurement configuration 210 may further indicate a step up size for increasing the threshold in an adjustment and/or a step down size for decreasing the threshold in an adjustment. For example, in addition to the adaptive threshold field, the RRC configuration may also include a field indicating how much the i1-threshold is updated in every update. The configuration may allow different sizes of the step-up and step-down, i.e., how much the threshold is increased or decreased in every update.

Alternatively or additionally, the CLI measurement configuration 210 may further indicate a maximum value for the adjusted threshold and/or a minimum value for the adjusted threshold. In other words, the network may also define the maximum and/or the minimum value that the i1-threshold can take. A possible implementation of the options above is summarized in the following RRC configuration:

| | |
|---|---|
| CLI-EventTriggerConfig-r16 ::= | SEQUENCE { |
| eventId-r16 | CHOICE { |
| eventI1-r16 | SEQUENCE { |
| i1-Threshold-r16 | MeasTriggerQuantityCLI-r16, |
| i1-AdaptiveThreshold | BOOLEAN, |
| stepUpAdaptiveThreshold | INTEGER, |
| stepDownAdaptiveThreshold | INTEGER, |
| maxValueAdaptiveThreshold | INTEGER, |
| minValueAdaptiveThreshold | INTEGER, |
| reportOnLeave-r16 | BOOLEAN, |
| hysteresis-r16 | Hysteresis, |
| timeToTrigger-r16 | TimeToTrigger |

},

Referring back to FIG. 2, the terminal device 201 receives 215 the CLI measurement configuration 210 and adjusts 220 the threshold based on DL channel quality. Similar to the i1-threshold discussed above, lowering the adaptive threshold may increase the chances of triggering a i1-event. The higher is the threshold, the lower is the probability that a CLI reporting event is triggered.

In some embodiments, the terminal device 201 may adjust the threshold based on the DL channel quality as follows. For example, the terminal device 201 can determine an instantaneous DL signal to interference plus noise ratio, SINR, or an average DL SINR over a number of periods. Then, the terminal device 201 can adjust the threshold based on the instantaneous DL SINR or the average DL SINR. In other words, the terminal device 201 may use the DL SINR as a metric for the threshold adaptation. As an example, the terminal device 201 may increase the threshold when the DL SINR is above an DL SINR threshold. Thus the CLI reporting may be not triggered due to good DL SINR conditions. As another example, the terminal device 201 may decrease the threshold as the DL SINR decreases.

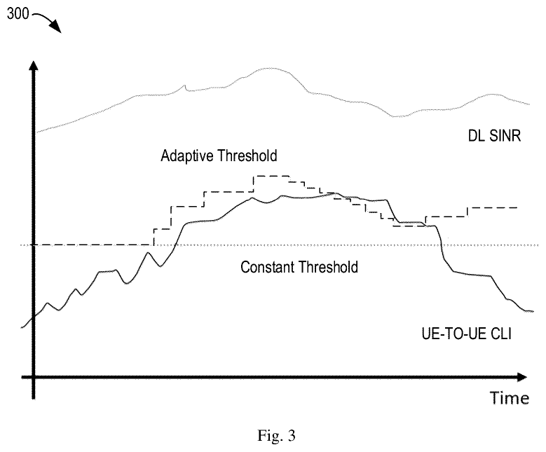

FIG. 3 illustrates an example 300 of the adaptive threshold according to some embodiments of the present disclosure. As illustrated in FIG. 3, the adaptive threshold may be adjusted based on the DL SINR. The adaptive threshold may be increased by a step up value as the DL SINR increases and the adaptive threshold may be decreased by a step down size as the DL SINR decreases. In this case, in contrast to the constant threshold, the adaptive threshold can delay the time of staring the CLI reporting and thus transmissions of the unnecessary CLI reporting can be reduced as the DL SINR is enough to decode correctly the DL reception.

In some embodiments, the terminal device 201 may adjust the threshold based on the DL channel quality by increasing the threshold by a step up size based on correct decoding of a received DL signal and/or decreasing the threshold by a step down size based on incorrect decoding of a received DL signal. That is, the terminal device 201 may increase the value of the i1-threshold by a step-up if the DL signal is received correctly. On the other hand, the i1-threshold may be decreased by a step-down if the DL is decoded incorrectly.

In some other embodiments, the terminal device 201 may adjust the threshold based on the DL channel quality by: increasing the threshold based on a predetermined number of consecutive correctly decoded DL signals. For example, the terminal device 201 may be configured to only increase the i1-threshold after it correctly received N consecutive physical downlink shared channel (PDSCH) signals or physical downlink control channel (PDCCH) signals. The predetermined number N may be also configured by the network. The predetermined number N for PDSCH signals and PDCCH signals may be the same or different.

In some further embodiments, the terminal device 201 may decrease the threshold for every incorrect decoding. Alternatively, the terminal device 201 may decrease the threshold by a step-down after a predetermined number of consecutive incorrectly-decoded DL signals.

In some still further embodiments, the terminal device 201 may adjust the threshold based on the DL channel quality as follows. For instance, the terminal device 201 can determine whether a DL signal is received on a control channel or data channel. Afterwards, the terminal device 201 can adjust the threshold based on a first weight associated with the control channel or a second weight associated with the data channel. For example, the penalty for a decoding failure on the control channel (PDCCH) and data channel (PDSCH) can be weighted differently in the i1-threshold adaptation. The reason is that the PDCCH is considered as a more robust channel than the data channel due to the use of a low modulation and coding scheme (MCS) orders and polar codes for the channel coding. The different ways of the threshold adaptation may be configured to the terminal device 201 as part of its RRC configuration.

An example of this implementation is show in Table 1 below. The Table 1 illustrates a DL channel and threshold step sizes mapping.

TABLE 1

| DL channel | Step-up [dB] | Step-down [dB] |
|---|---|---|
| PDCCH | 0.1 | 5 |
| PDSCH | 0.5 | 0.5 |

As another example, the terminal device 201 may be configured to only adjust the i1-threshold according to the PDSCH receptions without adjusting the i1-threshold according to the PDCCH receptions. For example, the step-up and/or step-down of the PDCCH may be set to 0.

Alternatively or additionally, the terminal device 201 may adjust the threshold based on the DL channel quality by adjusting the threshold based on a MCS of the scheduled DL signal. For example, the step-up and step-down of the i1-threshold may be MCS dependent. This implementation aims to differentiate cases, for instance, a case where the UE is allocated with a robust MCS due to e.g., stringent reliability requirements or poor channel quality indication (CQI)/channel conditions. In such cases, the UE is sensitive to decoding failures and therefore the adaptive threshold may only increase in small amounts in case of successful decoding. In a similar manner, the threshold may decrease with a larger step down size, if there is a DL decoding failure (to quickly trigger an i1-event).

An example of this implementation is show in Table 2. The Table 2 illustrates a MCS and i1-threshold step sizes mapping. Similarly, this mapping may be configured to the UE as part of its RRC configuration.

TABLE 2

| MCS (coding rate) | Step-up [dB] | Step-down [dB] |
|---|---|---|
| QPSK (1/3) | 0.1 | 5 |
| QPSK (2/3) | 0.1 | 3 |
| 16-QAM | 0.5 | 2 |
| 64-QAM | 2 | 1 |
| 256-QAM | 3 | 0.2 |

Alternatively or additionally, the terminal device 201 may adjust the threshold based on the DL channel quality by adjusting the threshold based on a quality of service (QOS) class. For example, the step-up and step-down of the i1-threshold may be QoS dependent. There could be a mapping between the 5QI or type of QoS class, e.g., ultra-reliable and low-latency communication (URLLC) and enhanced mobile broadband (eMBB) and the step-up and step-down size for the i1 threshold.

An example of this implementation is show in Table 3. The Table 3 illustrates a QoS class and i1-threshold step sizes mapping. Similarly, this mapping may be configured to the UE as part of its RRC configuration.

TABLE 1

| QoS class (5QI) | Step-up [dB] | Step-down [dB] |
|---|---|---|
| URLLC | 0.1 | 2.5 |
| eMBB | 2 | 0.5 |

Alternatively or additionally, the terminal device 201 may adjust the threshold based on the DL channel quality by adjusting the threshold based on a DL channel quality indication (CQI). For example, when the wideband DL-CQI increases by N dB, i1-threshold may increase by M*N dB, where M refers to the step-up size and N is the difference between the current CQI and the last CQI. When the wideband DL-CQI decreases by N dB, the i1-threshold may decrease by a L*N dB, where L refers to the step-down size and N is the difference between the current CQI and the last CQI.

As another example, when the UE measures a higher DL CQI, UE may have a higher i1-threshold, thus decreasing the frequency of the CLI reporting due to good channel conditions. An example of this implementation is show in Table 4 below. The Table 4 illustrates a DL-CQI index and i1-threshold value mapping. Moreover, in this embodiment, the UE and the network may know in advance the mapping between the wideband DL-CQI and i1-threshold such that there is no need for reporting the i1-threshold.

TABLE 4

| CQI index | I1-threshold value [dBm] |
|---|---|
| 4 | −90 dBm |
| 8 | −75 dBm |
| 15 | −50 dBm |

Alternatively or additionally, the terminal device 201 may adjust the threshold based on the DL channel quality by adjusting the threshold based on a reference signal receiving quality (RSRQ), a reference signal strength indicator (RSSI) and/or a wideband interference level.

Alternatively or additionally, the terminal device 201 may adjust the threshold based on the DL channel quality by adjusting the threshold based on a difference between a CLI measured in an UL sub-band and a CLI measured in a guard band. In the SBFD scheme, the i1-threshold may be updated according to the difference in power between the CLI measured in the UL sub-band and in the guard bands. This implementation attempts to favor higher number of reports if the difference between guard bands and UL sub-band CLI is low. This likely means that the CLI measured is leaking to the DL sub-bands too. A possible configuration for this implementation is shown in Table 5 below.

TABLE 5

| UL sub-band CLI - guard | | |
|---|---|---|
| band CLI [dB] | Step-up [dB] | Step-down [dB] |
| 30 dB or below | 0 | 5 |
| [30 dB to 40 dB] | 0 | 2.5 |
| [40 dB to 45 dB] (expected | 0 | 0 |
| interference difference) | | |
| 50 | 2.5 | 0.5 |
| 70 dB or above | 5 | 0 |

Further, it is advised that the terminal device 201 may only adjust the i1-threshold if a certain level of CLI is present over the UL sub-band. Otherwise, in a case where the difference of power is lower than 30 dB (e.g., −180 dBm in UL sub-band and −183 dBm in guard band), the UE may lower its i1-threshold, but in reality the CLI was not even present in the UL sub-band (−180 dBm is below the sensitivity threshold of the UE, meaning that there is no CLI at all in the UL sub-band). Thus, as an example, the UE may be configured to only apply the i1-threshold update based on the CLI power difference if the UL CLI is, at least, 10 dB lower than the current i1-threshold.

In some example implementations, the terminal device 201 may further stop adjusting the threshold based on a maximum number M of adjustments for the threshold per measurement period. The parameter M may also be configured by the network. The parameter M may be set different for increasing and decreasing of the threshold. For example, if the CLI is measured every 10 ms, the UE may be only allowed to perform 2 steps-up over the interval (assuming that successful decoding occurs during this interval), whereas it can decrease the threshold for every incorrect decoding.

In some other example implementations, the terminal device 201 may further adjust a report interval for the CLI reporting based on the DL channel quality, and then transmit the CLI report based on the adjusted report interval. In other words, by using at least one of the above metrics (e.g., DL SINR), the UE may adjust its report interval and/or the adaptive threshold. As an example, if the DL SINR is high, the UE may skip every N report, where N is configured by the network. As another example, the UE may increase the report interval when the DL channel quality is good enough.

In some further example implementations, the terminal device 201 may further adjust a hysteresis value for the CLI reporting based on the DL channel quality, and transmit the CLI report based on the adjusted hysteresis value. As an example, the network may define a dynamic hysteresis value that changes according to one or more metrics such as the block error rate (BLER) or MCS as discussed above. Alternatively, the terminal device 201 may keep the threshold constant and adjust the hysteresis value to change the chances of triggering the CLI reporting. Alternatively or additionally, the terminal device 201 may adjust any other suitable parameter involved in the i1-event triggering to achieve more efficient CLI reporting.

In some still further example implementations, the terminal device 201 may further start the CLI reporting or end the CLI reporting based on a comparison between the CLI measurement and an original threshold. For example, the adjusted threshold may be applied only for either trigger/entering/starting condition or cancel/leaving/ending condition of the CLI reporting. In some examples, the UE may still trigger the CLI reporting when the CLI is high, using a constant threshold, regardless of the DL SINR. However, the UE may stop the reporting earlier, using the adjustable threshold, when the DL SINR is high.

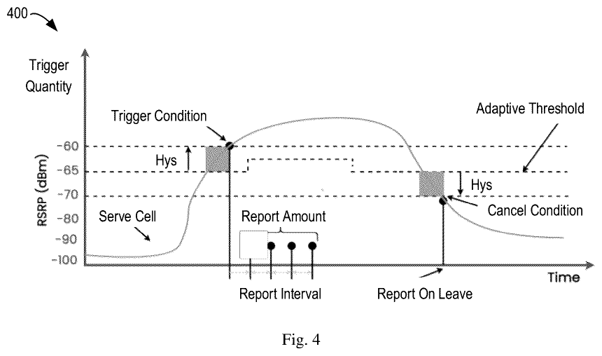

FIG. 4 illustrates an example 400 of a start and an end of the CLI reporting according to some embodiments of the present disclosure. As illustrated in FIG. 4, the trigger condition may be defined as the measured CLI being above a sum of the adaptive threshold and the hysteresis value, and the cancel condition may be defined as a sum of the measured CLI and the hysteresis value being below the adaptive threshold. Once the trigger condition is met, the UE may transmit CLI reports in the report intervals. According to the embodiments of the present disclosure, the UE may adjust any suitable parameter involved in the event triggered CLI reporting, e.g., the threshold, hysteresis value and report interval to achieve the more efficient CLI reporting.

Referring back to FIG. 2, the terminal device 201 determines 225 to transmit a CLI report based on the adjusted threshold and a CLI measurement. The terminal device 201 then transmits 230 the CLI report 235 to the network device 202, and the network device 202 receives 240 the CLI report 235. In some embodiments, the CLI report may comprise the adjusted threshold, such that the network may be updated with the adjusted threshold. Alternatively or additionally, the CLI report may comprise an actual CLI measurement that triggered the CLI reporting.

In some examples, the terminal device 201 may transmit to the network device, the CLI report based on the CLI measurement and the adjusted threshold by: transmitting the CLI report based on determining that the CLI measurement is above the adjusted threshold or a sum of the adjusted threshold and a hysteresis value. For example, as discussed with reference to FIG. 3, the trigger condition for the CLI reporting may be met when the CLI measurement is above the sum of the adjusted threshold and a hysteresis value.

In some other examples, once the event is triggered, the UE may transmit a CLI report to report the identification (ID) of the resources that triggered the event-i1 and the current value of the i1-threshold by the time that the event was triggered. This was not needed in the i1-event since the gNB was in control of the threshold and the event notification was enough (as specified in 3GPP TS 38.331). An example of the modified CLI reporting is shown below.

| > | if there is at least one applicable CLI measurement resource to report: | |
|---|---|---|
| | 2> | if the reportType is set to cli-EventTriggered or cli-Periodical: |

| | |
|---|---|
| 3> | set the measResultCLI to include the most interfering SRS resources or most interfering CLI- |

| RSSI resources up to maxReportCLI in accordance with the following: | |
|---|---|
| 4> | if the reportType is set to cli-EventTriggered: |

| | |
|---|---|
| 5> | if trigger quantity is set to srs-RSRP i.e. i1-Threshold is set to srs-RSRP: |

| | |
|---|---|
| 6> | include the SRS resource included in the cli-TriggeredList as defined within the |

VarMeasReportList for this measId;

| | |
|---|---|
| 5> | if trigger quantity is set to cli-RSSI i.e. i1-Threshold is set to cli-RSSI: |

| | |
|---|---|
| 6> | include the CLI-RSSI resource included in the cli-TriggeredList as defined within |

the VarMeasReportList for this measId;

| | |
|---|---|
| 5> | if trigger quantity is set to srs-RSRP i.e. i1-Threshold is set to srs-RSRP and i1- |

| AdaptiveThreshold: | |
|---|---|
| 6> | include the SRS resource included in the cli-TriggeredList as defined within the |
| | VarMeasReportList for this measId; |
| 6> | include the i1-Threshold value that triggered the event within the |

VarMeasReportList for this measId;

| | |
|---|---|
| 5> | if trigger quantity is set to cli-RSSI i.e. i1-Threshold is set to cli-RSSI and i1- |

| AdaptiveThreshold: | |
|---|---|
| 6> | include the CLI-RSSI resource included in the cli-TriggeredList as defined within |
| | the VarMeasReportList for this measId; |
| 6> | include the i1-Threshold value that triggered the event within the |

VarMeasReportList for this measId;

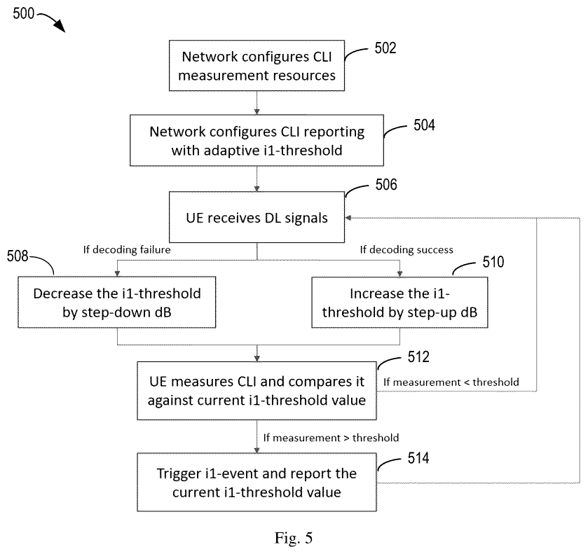

FIG. 5 illustrates an example of a process 500 of the CLI reporting based on decoding of DL signals according to some embodiments of the present disclosure. The process 500 may be deemed as a detailed example of the process 200. As illustrated in FIG. 5, at block 502, the network, e.g., network device 202 may configure CLI measurement resources to the UE, e.g., terminal device 201. At block 504, the network may configure the CLI reporting with an adaptive i1-threshold. For example, the network may transmit a CLI measurement and reporting configuration to the UE to indicate an adaptive i1-threshold. At block 506, the UE may receive DL signals from the network. If a DL signal is decoded incorrectly, at block 508 the UE may decrease the i1-threshold by a step-down size. If a DL signal is decoded successfully, at block 510 the UE may increase the i1-threshold by a step-up size.

At block 512, the UE may measure the CLI and compare the CLI measurement against the current i1-threshold value. If the CLI measurement is below the threshold, the UE may not trigger the CLI reporting and keep measuring the CLI. If the CLI measurement is above the threshold, at block 514 the UE may trigger the i1-event and report the current i1-threshold value to the network.

With the CLI reporting according to the embodiments of the present disclosure, the number of event triggered CLI reports can be reduced thanks to the association between the DL channel quality, e.g., DL SINR and the i1-threshold. The association between the DL SINR and the threshold also helps in SBFD deployments. For instance, the unnecessary CLI report can be avoided in cases where the CLI over the UL sub-band is high but the effect on the DL SINR is marginal because the i1-threshold may be increased to a level above the CLI over the UL sub-band.

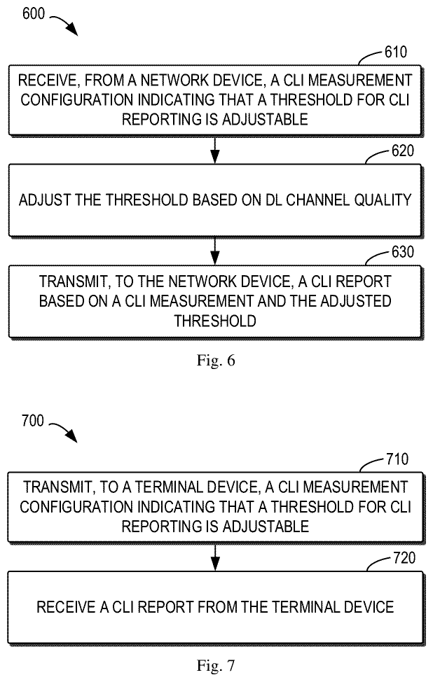

FIG. 6 shows a flowchart of an example method 600 implemented at a terminal device in accordance with some embodiments of the present disclosure. For the purpose of discussion, the method 600 will be described from the perspective of the terminal device 201 with reference to FIG. 2.

At block 610, the terminal device 201 receives, from a network device, a cross-link interference, CLI, measurement configuration, wherein the CLI measurement configuration indicates that a threshold for CLI reporting is adjustable. At block 620, the terminal device 201 adjusts the threshold based on downlink, DL, channel quality. At block 630, the terminal device 201 transmits, to the network device, a CLI report based on a CLI measurement and the adjusted threshold.

In some embodiments, the CLI report may comprise the adjusted threshold. In some embodiments, the CLI measurement configuration may comprise an adaptive threshold field indicating that the threshold is adjustable.

In some embodiments, the CLI measurement configuration may further indicate at least one of the following: a step up size for increasing the threshold in an adjustment, a step down size for decreasing the threshold in an adjustment, a maximum value for the adjusted threshold, or a minimum value for the adjusted threshold.

In some embodiments, the terminal device 201 may adjust the threshold based on the DL channel quality by: determining an instantaneous DL signal to interference plus noise ratio, SINR, or an average DL SINR over a number of periods; and adjusting the threshold based on the instantaneous DL SINR or the average DL SINR.

In some embodiments, the terminal device 201 may adjust the threshold based on the DL channel quality by at least one of the following: increasing the threshold by a step up size based on correct decoding of a received DL signal, or decreasing the threshold by a step down size based on incorrect decoding of a received DL signal.

In some embodiments, the terminal device 201 may adjust the threshold based on the DL channel quality by: determining whether a DL signal is received on a control channel or data channel; and adjusting the threshold based on a first weight associated with the control channel or a second weight associated with the data channel.

In some embodiments, the terminal device 201 may adjust the threshold based on the DL channel quality by adjusting the threshold based on at least one of the following: a modulation and coding scheme, MCS, a quality of service, QoS, class, a DL channel quality indication, CQI, a reference signal receiving quality, RSRQ, a reference signal strength indicator, RSSI, or a wideband interference level.

In some embodiments, the terminal device 201 may adjust the threshold based on the DL channel quality by adjusting the threshold based on: a difference between a CLI measured in an uplink, UL, sub-band and a CLI measured in a guard band.

In some embodiments, the terminal device 201 may transmit to the network device, the CLI report based on the CLI measurement and the adjusted threshold by: transmitting the CLI report based on determining that the CLI measurement is above the adjusted threshold or a sum of the adjusted threshold and a hysteresis value.

In some embodiments, the terminal device 201 may further start the CLI reporting or end the CLI reporting based on a comparison between the CLI measurement and an original threshold.

In some embodiments, the terminal device 201 may further adjust a report interval for the CLI reporting based on the DL channel quality; and transmit the CLI report based on the adjusted report interval.

In some embodiments, the terminal device 201 may further adjust a hysteresis value for the CLI reporting based on the DL channel quality; and transmit the CLI report based on the adjusted hysteresis value.

In some embodiments, the terminal device 201 may adjust the threshold based on the DL channel quality by: increasing the threshold based on a predetermined number of consecutive correctly-decoded DL signals.

In some embodiments, the terminal device 201 may further stop adjusting the threshold based on a maximum number of adjustments for the threshold per measurement period. In some embodiments, the CLI measurement may be a CLI-RSSI measurement or a sounding reference signal, SRS, reference signal received power, RSRP, measurement.

FIG. 7 shows a flowchart of an example method 700 implemented at a network device in accordance with some embodiments of the present disclosure. For the purpose of discussion, the method 700 will be described from the perspective of the network device 202 with reference to FIG. 2.

At block 710, the network device 202 transmits, to a terminal device, a cross-link interference, CLI, measurement configuration, wherein the CLI measurement configuration indicates that a threshold for CLI reporting is adjustable. At block 720, the network device 202 receives a CLI report from the terminal device.

In some embodiments, the CLI report may comprise the threshold adjusted by the terminal device. In some embodiments, the CLI measurement configuration may comprise an adaptive threshold field indicating that the threshold is adjustable.

In some embodiments, the CLI measurement configuration may further indicate at least one of the following: a step up size for increasing the threshold in an adjustment, a step down size for decreasing the threshold in an adjustment, a maximum value for the adjusted threshold, or a minimum value for the adjusted threshold.

In some embodiments, the CLI report may comprise a CLI measurement and the CLI measurement may be a CLI-RSSI measurement or a sounding reference signal, SRS, reference signal received power, RSRP, measurement.

In some embodiments, an apparatus capable of performing any of the method 600 (for example, the terminal device 201) may comprise means for performing the respective steps of the method 600. The means may be implemented in any suitable form. For example, the means may be implemented in a circuitry or software module.

In some embodiments, the apparatus comprises: means for receiving, at a terminal device and from a network device, a cross-link interference, CLI, measurement configuration, wherein the CLI measurement configuration indicates that a threshold for CLI reporting is adjustable; means for adjusting, at the terminal device, the threshold based on downlink, DL, channel quality; and means for transmitting, at the terminal device and to the network device, a CLI report based on a CLI measurement and the adjusted threshold.

In some embodiments, the CLI report may comprise the adjusted threshold. In some embodiments, the CLI measurement configuration may comprise an adaptive threshold field indicating that the threshold is adjustable.

In some embodiments, the CLI measurement configuration may further indicate at least one of the following: a step up size for increasing the threshold in an adjustment, a step down size for decreasing the threshold in an adjustment, a maximum value for the adjusted threshold, or a minimum value for the adjusted threshold.

In some embodiments, the means for adjusting the threshold based on the DL channel quality may comprise means for: determining an instantaneous DL signal to interference plus noise ratio, SINR, or an average DL SINR over a number of periods; and adjusting the threshold based on the instantaneous DL SINR or the average DL SINR.

In some embodiments, the means for adjusting the threshold based on the DL channel quality may comprise at least one of the following: means for increasing the threshold by a step up size based on correct decoding of a received DL signal, or means for decreasing the threshold by a step down size based on incorrect decoding of a received DL signal.

In some embodiments, the means for adjusting the threshold based on the DL channel quality may comprise means for: determining whether a DL signal is received on a control channel or data channel; and adjusting the threshold based on a first weight associated with the control channel or a second weight associated with the data channel.

In some embodiments, the means for adjusting the threshold based on the DL channel quality may comprise means for adjusting the threshold based on at least one of the following: a modulation and coding scheme, MCS, a quality of service, QoS, class, a DL channel quality indication, CQI, a reference signal receiving quality, RSRQ, a reference signal strength indicator, RSSI, or a wideband interference level.

In some embodiments, the means for adjusting the threshold based on the DL channel quality may comprise means for adjusting the threshold based on: a difference between a CLI measured in an uplink, UL, sub-band and a CLI measured in a guard band.

In some embodiments, the means for transmitting to the network device, the CLI report based on the CLI measurement and the adjusted threshold may comprise means for transmitting the CLI report based on determining that the CLI measurement is above the adjusted threshold or a sum of the adjusted threshold and a hysteresis value.

In some embodiments, the apparatus may further comprise means for starting the CLI reporting or ending the CLI reporting based on a comparison between the CLI measurement and an original threshold.

In some embodiments, the apparatus may further comprise means for adjusting a report interval for the CLI reporting based on the DL channel quality; and transmitting the CLI report based on the adjusted report interval.

In some embodiments, the apparatus may further comprise means for adjusting a hysteresis value for the CLI reporting based on the DL channel quality; and transmitting the CLI report based on the adjusted hysteresis value.

In some embodiments, the means for adjusting the threshold based on the DL channel quality may comprise means for increasing the threshold based on a predetermined number of consecutive correctly-decoded DL signals.

In some embodiments, the apparatus may further comprise means for stopping adjusting the threshold based on a maximum number of adjustments for the threshold per measurement period. In some embodiments, the CLI measurement may be a CLI-RSSI measurement or a sounding reference signal, SRS, reference signal received power, RSRP, measurement.

In some embodiments, the apparatus further comprises means for performing other steps in some embodiments of the method 600. In some embodiments, the means comprises at least one processor; and at least one memory including computer program code, the at least one memory and computer program code configured to, with the at least one processor, cause the performance of the apparatus.

In some embodiments, an apparatus capable of performing any of the method 700 (for example, the network device 202) may comprise means for performing the respective steps of the method 700. The means may be implemented in any suitable form. For example, the means may be implemented in a circuitry or software module.

In some embodiments, the apparatus comprises: means for transmitting, at a network device and to a terminal device, a cross-link interference, CLI, measurement configuration, wherein the CLI measurement configuration indicates that a threshold for CLI reporting is adjustable; and means for receiving, at the network device, a CLI report from the terminal device.

In some embodiments, the CLI report may comprise the threshold adjusted by the terminal device. In some embodiments, the CLI measurement configuration may comprise an adaptive threshold field indicating that the threshold is adjustable.

In some embodiments, the CLI measurement configuration may further indicate at least one of the following: a step up size for increasing the threshold in an adjustment, a step down size for decreasing the threshold in an adjustment, a maximum value for the adjusted threshold, or a minimum value for the adjusted threshold.

In some embodiments, the CLI report may comprise a CLI measurement and the CLI measurement may be a CLI-RSSI measurement or a sounding reference signal, SRS, reference signal received power, RSRP, measurement.

In some embodiments, the apparatus further comprises means for performing other steps in some embodiments of the method 700. In some embodiments, the means comprises at least one processor; and at least one memory including computer program code, the at least one memory and computer program code configured to, with the at least one processor, cause the performance of the apparatus.

FIG. 8 is a simplified block diagram of a device 800 that is suitable for implementing embodiments of the present disclosure. The device 800 may be provided to implement the communication device, for example the terminal device 201 and the network device 202 as shown in FIG. 2. As shown, the device 800 includes one or more processors 810, one or more memories 840 coupled to the processor 810, and one or more communication modules 840 coupled to the processor 810.

The communication module 840 is for bidirectional communications. The communication module 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIGS. 2 to 7. The embodiments of the present disclosure may also be implemented by hardware or by a combination of software and hardware.

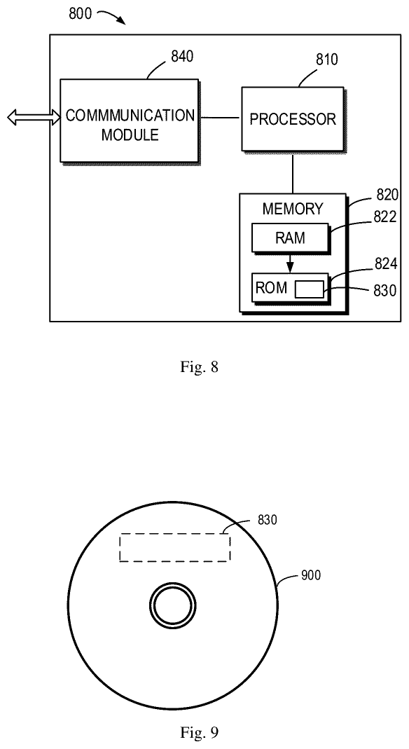

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 or 700 as described above with reference to FIGS. 2-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
receive, from a network device, a cross-link interference, CLI, measurement configuration, wherein the CLI measurement configuration indicates that a threshold for CLI reporting is adjustable;
adjust the threshold based on downlink, DL, channel quality; and
transmit, to the network device, a CLI report based on a CLI measurement and the adjusted threshold.

2. The terminal device of claim 1, wherein the CLI report comprises the adjusted threshold.

3. The terminal device of claim 1, wherein the CLI measurement configuration comprises an adaptive threshold field indicating that the threshold is adjustable.

4. The terminal device of claim 1, wherein the CLI measurement configuration further indicates at least one of the following:
a step up size for increasing the threshold in an adjustment,
a step down size for decreasing the threshold in an adjustment,
a maximum value for the adjusted threshold, or
a minimum value for the adjusted threshold.

5. The terminal device of claim 1, wherein the terminal device is caused to adjust the threshold based on the DL channel quality by:
determining an instantaneous DL signal to interference plus noise ratio, SINR, or an average DL SINR over a number of periods; and
adjusting the threshold based on the instantaneous DL SINR or the average DL SINR.

6. The terminal device of claim 1, wherein the terminal device is caused to adjust the threshold based on the DL channel quality by at least one of the following:
increasing the threshold by a step up size based on correct decoding of a received DL signal, or
decreasing the threshold by a step down size based on incorrect decoding of a received DL signal.

7. The terminal device of claim 1, wherein the terminal device is caused to adjust the threshold based on the DL channel quality by:
determining whether a DL signal is received on a control channel or data channel; and
adjusting the threshold based on a first weight associated with the control channel or a second weight associated with the data channel.

8. The terminal device of claim 1, wherein the terminal device is caused to adjust the threshold based on the DL channel quality by adjusting the threshold based on at least one of the following:
a modulation and coding scheme, MCS,
a quality of service, QoS, class,
a DL channel quality indication, CQI,
a reference signal receiving quality, RSRQ,
a reference signal strength indicator, RSSI, or
a wideband interference level.

9. The terminal device of claim 1, wherein the terminal device is caused to adjust the threshold based on the DL channel quality by adjusting the threshold based on:
a difference between a CLI measured in an uplink, UL, sub-band and a CLI measured in a guard band.

10. The terminal device of claim 1, wherein the terminal device is caused to transmit to the network device, the CLI report based on the CLI measurement and the adjusted threshold by:
transmitting the CLI report based on determining that the CLI measurement is above the adjusted threshold or a sum of the adjusted threshold and a hysteresis value.

11. The terminal device of claim 1, wherein the terminal device is further caused to:
start the CLI reporting or end the CLI reporting based on a comparison between the CLI measurement and an original threshold.

12. The terminal device of claim 1, wherein the terminal device is further caused to:
adjust a report interval for the CLI reporting based on the DL channel quality; and
transmit the CLI report based on the adjusted report interval.

13. The terminal device of claim 1, wherein the terminal device is further caused to:
adjust a hysteresis value for the CLI reporting based on the DL channel quality; and
transmit the CLI report based on the adjusted hysteresis value.

14. The terminal device of claim 1, wherein the terminal device is caused to adjust the threshold based on the DL channel quality by:
increasing the threshold based on a predetermined number of consecutive correctly-decoded DL signals.

15. The terminal device of claim 1, wherein the terminal device is further caused to:
stop adjusting the threshold based on a maximum number of adjustments for the threshold per measurement period.

16. The terminal device of claim 1, wherein the CLI measurement is a CLI-RSSI measurement or a sounding reference signal, SRS, reference signal received power, RSRP, measurement.

17. An network device comprising:
at least one processor; and
at least one memory storing instructions that, when executed by the at least one processor, cause the network device at least to:
transmit, to a terminal device, a cross-link interference, CLI, measurement configuration, wherein the CLI measurement configuration indicates that a threshold for CLI reporting is adjustable; and
receive a CLI report from the terminal device.

18. (canceled)

19. The network device of claim 17, wherein the CLI measurement configuration comprises an adaptive threshold field indicating that the threshold is adjustable.

20. The network device of claim 17, wherein the CLI measurement configuration further indicates at least one of the following:
a step up size for increasing the threshold in an adjustment,
a step down size for decreasing the threshold in an adjustment,
a maximum value for the adjusted threshold, or
a minimum value for the adjusted threshold.

21. (canceled)

22. A method comprising:
receiving, at a terminal device and from a network device, a cross-link interference, CLI, measurement configuration, wherein the CLI measurement configuration indicates that a threshold for CLI reporting is adjustable;
adjusting, at the terminal device, the threshold based on downlink, DL, channel quality; and
transmitting, at the terminal device and to the network device, a CLI report based on a CLI measurement and the adjusted threshold.

23-26. (canceled)
